(19) United States
(12) Patent Application Publication
(10) Pub. No.: US 2024/0400076 A1
(43) Pub. Date: Dec. 5, 2024

(54) System and Method for Geolocated In-Vehicle False Alarm Filtering and Proactive True Alarm Early Warning

(71) Applicant: Bendix Commercial Vehicle Systems LLC, Avon, OH (US)

(72) Inventors: Andre Tokman, San Clemente, CA (US); Andreas U. Kuehnle, Villa Park, CA (US); Hans Molin, Mission Viejo, CA (US)

(73) Assignee: Bendix Commercial Vehicle Systems LLC, Avon, OH (US)

(21) Appl. No.: 18/203,859

(22) Filed: May 31, 2023

(51) Int. Cl. B60W 50/14

(52) U.S. Cl. CPC B60W 50/14; B60W 2050/143; B60W 2555/20

(57) ABSTRACT

Some vehicles can be equipped with a safety system that provides audible and/or visual alerts in response to excessive speed or other safety violations. The system can also generate a report of a safety violation. In some situations, the alerts and/or reports that are generated are false alarms. In other situations, the condition that triggered a true alarm can be prevented if advance warning is given to the driver. In the embodiments herein, a system and method for geolocated in-vehicle false alarm filtering and proactive true alarm early warning are provided that can address these issues.

### BACKGROUND

Some vehicles (e.g., a tractor capable of towing a trailer) can be equipped with a safety system that provides audible and/or visual alerts to a driver in response to excessive speed or other safety violations. The alert can prompt the driver to reduce speed or take some other action. A record evidencing the fact that the alert was generated can be stored in the vehicle and/or transmitted to an external entity for later review or action by the driver's supervisor. Depending on a number or frequency of alerts that were generated, the driver may be subject to coaching or disciplinary action.

### BRIEF DESCRIPTION OF THE DRAWINGS

FIG. 1 is a block diagram of a vehicle of an embodiment.

FIG. 2 is a diagram illustrating a situation with a confusing road sign.

FIG. 3 is a flow chart of a method of an embodiment for geolocated in-vehicle false-alarm filtering.

FIG. 4 is a flow chart of a method of an embodiment for determining whether a vehicle is approaching a designated geographic area.

FIG. 5 is a flow chart of a method of an embodiment for geolocated in-vehicle proactive true alarm early warning.

FIG. 6 is a diagram illustrating a fork in a road.

FIG. 7 is a diagram illustrating a sudden curve on a road on one side of a fork.

### SUMMARY

The following embodiments relate to a system and method for geolocated in-vehicle false alarm filtering and proactive true alarm early warning. In one embodiment, a non-transitory computer-readable storage medium is provided storing computer-readable instructions that, when executed by one or more processors in a vehicle, cause the one or more processors to: determine whether the vehicle is approaching a designated geographic area; and in response to determining that the vehicle is approaching the designated geographic area, perform at least one of the following: suppress an alarm that would otherwise be activated when the vehicle is in the designated geographic area; or indicate that the alarm, if activated when the vehicle is in the designated geographic area, is a false alarm.

In another embodiment, a method is provided that is performed in one or more processors in a vehicle. The method comprises: determining whether the vehicle is approaching a designated geographic area in a vehicle state that would activate an alarm when the vehicle enters the designated area; and in response to determining that the vehicle is approaching the designated geographic area in the vehicle state that would activate the alarm, issuing an advisory alert to alert a driver of the vehicle to change the vehicle state to avoid activation of the alarm when the vehicle enters the designated area.

In yet another embodiment, a vehicle is provided comprising: a safety system; and at least one of the following: means for suppressing an alarm of the safety system that would overwise be activated when the vehicle is in a geographic area; means for indicating that the alarm, if activated when the vehicle is in designated geographic area, is a false alarm; or means for issuing an advisory alert to alert a driver of the vehicle to change a vehicle state to avoid activation of the alarm when the vehicle is in the geographic area.

In another embodiment, a non-transitory computer-readable storage medium is provided storing computer-readable instructions that, when executed by one or more processors, cause the one or more processors to: receive, from a vehicle, an indication that an alarm was generated when the vehicle entered a geographic area; determine whether the alarm was a false alarm based on a history of false alarms in the geographic area; and in response to determining that the alarm was a false alarm, perform at least one of the following: refrain from placing the indication on a record of a driver of the vehicle; or remove the indication from the record of the driver of the vehicle.

Other embodiments are possible, and each of the embodiments can be used alone or together in combination.

### DETAILED DESCRIPTION

As mentioned above, some vehicles (e.g., a tractor capable of towing a trailer) can be equipped with a safety system that provides audible and/or visual alerts to a driver in response to excessive speed or other safety violations. The alert can prompt the driver to reduce speed or take some other action. A record evidencing the fact that the alert was generated can be stored in the vehicle and/or transmitted to an external entity for later review or action by the driver's supervisor. Depending on a number or frequency of alerts that were generated, the driver may be subject to coaching or disciplinary action.

In some situations, the alerts that are generated are false alarms. In other situations, the condition that triggered a true alarm can be prevented or mitigated if advance warning is given to the driver. The following embodiments can be used to address those situations. Before turning to a discussion of those embodiments, the following paragraphs provide a description of an example vehicle of an embodiment. It should be understood that this and the other examples presented herein are merely examples and that other implementations can be used. Accordingly, none of the details below should be read into the claims unless expressly recited therein.

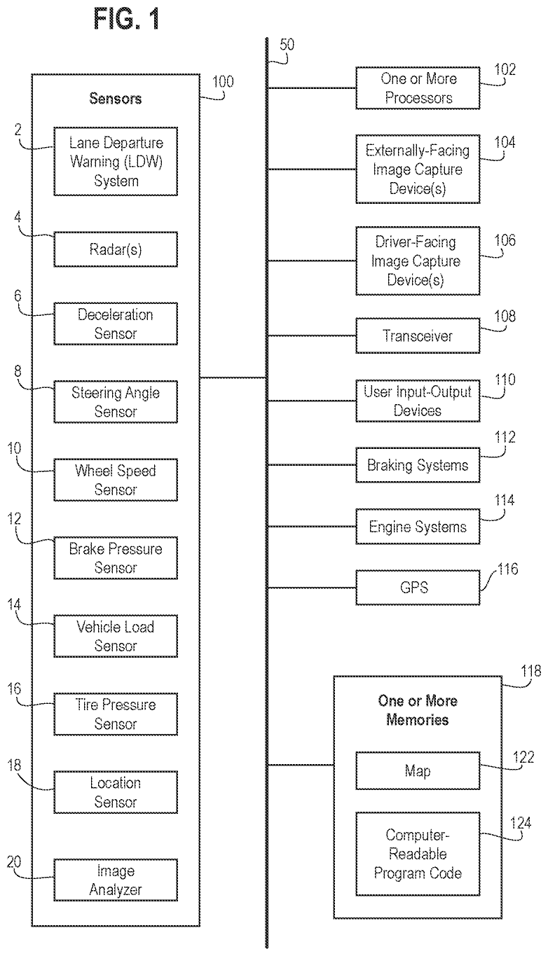

Turning now to the drawings, FIG. 1 is a block diagram of a vehicle of an embodiment, which takes the form of a tractor capable of towing a trailer, although other types of vehicles can be used. As shown in FIG. 1, the vehicle in this example comprises a plurality of sensors 100, one or more processors 102, externally-facing image capture device(s) (e.g., camera(s)) 104, driver-facing image capture device(s) 106, a transceiver 108, user input-output (IO) devices 110 (e.g., a microphone, a speaker, a touchscreen, indicator lights, etc.), a braking system 112, an engine system 114, a global positioning system (GPS) 116 that can identify a location of the vehicle, and one or more memories 118. These various components can be in communication with each other directly or indirectly (through components that may or may not be shown or described herein) via wired or wireless connections. In the example in FIG. 1, the components are directly or indirectly connected via a bus 50, which can take the form of a controller area network (CAN).

In this example, the plurality of sensors 100 comprises a lane departure warning (LDW) system 2, radar(s) 4, a deceleration sensor 6, a steering angle sensor 8, a wheel speed sensor 10, a brake pressure sensor 12, a vehicle load sensor 14, a time pressure sensor 16, a location (e.g., GPS) sensor 18, and an image analyzer 20. Again, these are merely examples, and the vehicle can have more or fewer sensors and/or different types of sensors. Also, in this example, the one or more memories 116 store a map 122 and computer-readable program code 124. These one or more memories 116 can be the same type or different types and can be part of the same memory device or be different memory devices. For example, some or all of the memories in the one or more memories 116 can be volatile or non-volatile non-transitory memory, solid state memory, flash memory, random-access memory (RAM), read-only memory (ROM), programmable read-only memory (PROM), erasable programmable read-only memory (EPROM), electronic erasable programmable read-only memory (EEPROM), and variants and combinations thereof.

The one or more processors 102 can execute the computer-readable program code 124, which can have instructions (e.g., modules, routines, sub-routine, programs, applications, etc.) that, when executed by the one or more processors 102, cause the one or more processors 102 to perform certain functions, such as those discussed herein as well as other functions not described herein. It should be noted that the one or more processors 102 can have different functions (e.g., a first subset of one or more processors can be used for certain functions, while a second subset of one or more processors can be used for other certain functions). The one or more processors 102 can also take the form of a purely-hardware implementation (e.g., an application-specific integrated circuit (ASIC)).

The various components discussed above can be used as part of the vehicle's safety system. For example, the one or more processors 102 can obtain an image of a posted speed limit sign from the externally-facing camera 104 and compare it against the vehicle's speed determined from the wheel speed sensor 10. If the vehicle speed exceeds the speed limit, the one or more processors 102 can issue an audible and/or visual alert via the various output devices 110 in the vehicle and/or can store a record of an excessive speed violation in the one or memories 118 for later review (or the record can be transmitted to an external entity via the transceiver 108). As another example, the one or more processors 102 can issue an audible and/or visual alert and/or record a violation in response to the LDW system 2 indicating one or more lane departures. As yet another example, the one or more processors 102 can issue an audible and/or visual alert and/or record a violation in response to excessive braking. It should be understood that these are merely examples and that the safety system can monitor for other situations.

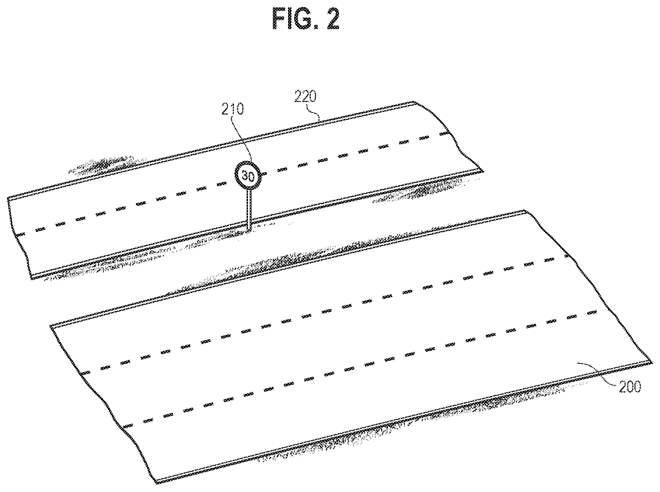

As discussed above, in some situations, the safety system can generate an alert and/or record a safety violation when, in fact, a safety violation did not occur. For example, with reference to FIG. 2, consider the situation in which a driver is driving a vehicle on a highway 200, and there is a speed sign 210 next to a frontage road 220 adjacent to the highway 200. The speed sign 210 indicates a speed limit of 30 miles per hour (MPH) for the Frontage Road 220, whereas the speed limit for the highway 200 continues to be 60 MPH (although that speed limit is not posted in the geographic area near the speed sign 210 for the frontage road 220). When the vehicle's forward-facing camera 104 sees the speed sign 210, the safety system reads the sign and incorrectly sets the safety speed limit at 30 MPH. So, if the vehicle is travelling at the appropriate speed limit of 60 MPH, the safety system will generate a false alarm. Such a false alarm can be annoying, cause unnecessary stress, and can lead to a distorted, even tragic, interpretation of reality (e.g., a “boy crying wolf too often loses his flock” situation). In the context of driving, false alarms can lead to true warnings being ignored, time being wasted on unnecessary coaching and data cleanup (e.g., removing a false positive violation from the driver's record), and compromised traffic safety. Examples of false positives include, but are not limited to, a stop sign on a nearby frontage road that causes automatic emergency braking and an apparent running of a stop sign that is read as “speed shall equal zero.”

The following embodiments can be used to address this false alarm situation by using an in-vehicle location-based system to suppress false alarms and/or false violation records. For example, with reference to FIG. 1, the map 122 stored in the one or more memories 118 can indicate various geographic areas that have confusing frontage road speed signs or any other condition that can generate a false alarm. Using the location of the vehicle (e.g., as indicated by the GPS 116), the one or more processors 102 can determine if the vehicle is approaching one of the indicated geographic areas. If it is, the one or more processors 102 can temporarily turn off alarm(s) that would otherwise be false alarm(s). Alternatively, if a false alarm is generated, the one or more processors 102 can indicate that the generated alarm was a false alarm and not transmit it from the vehicle. In this way, the driver is not later penalized for a safety violation that did not, in fact, occur. This also avoids the driver wasting time trying to expunge the bogus violation from his record.

This embodiment will now be discussed in more detail. In one example, a map-based technique is used. More specifically, as noted above, many vehicles use the highway, and speed limit signs on a frontage road can lead to a high rate of speeding alarms (or other alarms, including, but not limited to, LDWs on a curvy road, excessive braking on a hilly road with poor visibility, cross traffic accidents, etc.). The locations where such alarms are generated can be tracked and noted on the map 122 stored in the vehicle. In this way, collocated, confusing, false-alarm-triggered areas can be noted. However, due to the details of imaging, processing time, and varying speeds, the exact alarm location may be “smeared out” into a longer cloud or streak on the map 122. The rate of speeding alarms per mile on the map 122 can be visualized as a hot spot. Computationally, areas of excessively-high alarm rates can be detected (e.g., 20% of vehicles passing a given section of the road area of say 200 meters have speeding alarms, whereas the average rate is 3% when all sections are considered). An examination (manual or automated) of the section can be performed, and the confounding road's proximity can be verified (or not). If there is a confounding road, the false alarm locations can be noted on the map 122 (e.g., as a cloud, a bounding box, a bounding ellipse, a polygon, etc., depending on the local geometry). The presence of a vehicle within the bounds can be determined in a computationally-efficient way and serve to “gate” the alarm. The type of (locally) gated alarm is stored along with the area (e.g., not all alarm types may need to be suppressed). Directionality can be considered (e.g., if there is a speed sign only on one side of the highway) in the calculation. It should be noted that the map 122 can be updated (e.g., via the transceiver 108) over time with collated localized high-alarm-frequency locations. Additionally, the one or more processors 102 can store a trigger-condition history for the alarm and associated geographic location for future evaluation and possible trigger refinement (“permissive” trigger conditions may cause unnecessary “false” alarms).

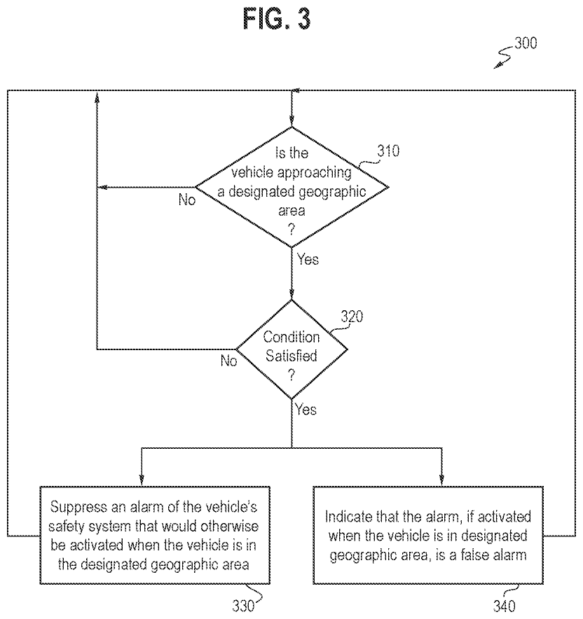

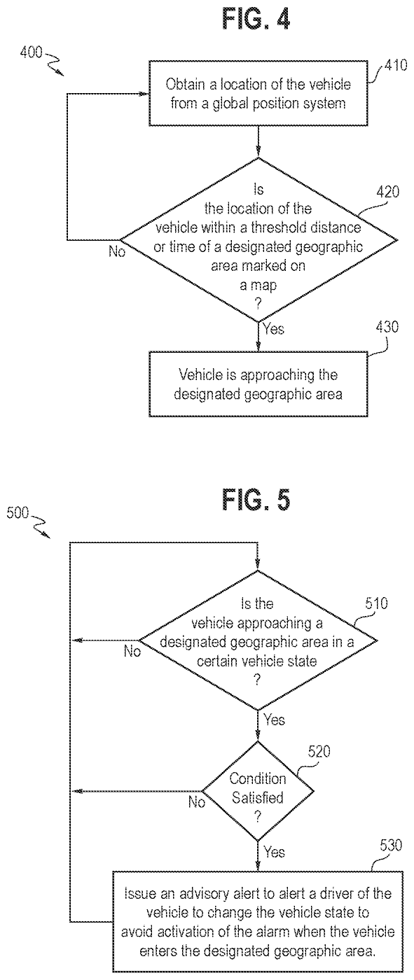

Turning again to the drawings, FIG. 3 is a flow chart 300 of a method of an embodiment for geolocated in-vehicle false-alarm filtering using the map-based technique noted above. As shown in FIG. 3, the one or more processors 102 determine if the vehicle is approaching a designated geographic area (act 310). This can be determined in any suitable way. For example, as shown in the flow chart 400 in FIG. 4, the one or more processors 102 can obtain a location of the vehicle from the vehicle's GPS 116 (act 410) and then determine if the location of the vehicle is within a threshold distance or time of a designated geographic area marked on the map 122 as having condition(s) (e.g., confusing road signage) what would trigger a false alert (act 420). If the vehicle is determined to be within a threshold distance or time of a designated geographic area marked on the map, the one or more processors 102 can conclude that the vehicle is approaching a designated geographic area (act 430).

Returning to FIG. 3, the one or more processors 102 can optionally determine a condition that exists when the vehicle is approaching the designated area (act 320). For example, it may be desired to suppress an alarm or indicate that a generated alarm is a false alarm only when the condition satisfies a criterion, such as, but not limited to, a designated time, a designated date, a designated weekday, a designated weather condition, and/or designated a road condition. If the condition satisfies the criterion, the one or more processors 102 can then suppress an alarm of the vehicle's safety system that would overwise be activated when the vehicle is in the designated geographic area (act 330). (If the vehicle has multiple alarms (e.g., an excessive speed alarm, a lane departure alarm, an excessive braking alarm, an excessive curve speed alarm, an electronic stability control (ESC) alarm, an electronic stability program (ESP) alarm, a roll stability control (RSC) alarm, and/or a roll stability program (RSP) alarm, etc.), the one or more processors 102 can determine which of the plurality of alarms to suppress.) By suppressing the false alarm, the disadvantages noted above are avoided. Alternatively, the one or more processors 102 can indicate that an alarm, if activated when the vehicle is in designated geographic area, is a false alarm (act 340). Transmission of these false alarms from the vehicle may then be suppressed. This avoids the driver later being disciplined for the false alarm or wasting gtime trying to remove the false alarm from his record.

Turning now to another embodiment, as mentioned above, there may be situations in which a true alarm can be prevented if advance warning is given to the driver. For example, there may be an intersection at the end of a long downhill road where a slow speed is warranted and near which a speed sign is placed. The map 122 can indicate this area as a hot spot if a large number of alerts are generated in this area. Since a true alarm can be avoided if the driver is provided with sufficient notice in this situation, in one embodiment, the one or more processors 102 can issue a preemptory advisory alert to alert a driver of the vehicle to change the vehicle's state (e.g., speed) to avoid activation of the alarm when the vehicle enters the designated area. For example, the driver coming down the hill can be preemptively warned (e.g., via an alarm/alert or advisory of a distinctly-different character than a typical alarm) prior to seeing the speed sign to give the driver the opportunity to avoid the true alarm. This has the advantage of reducing the rate of true alarms and increasing safety

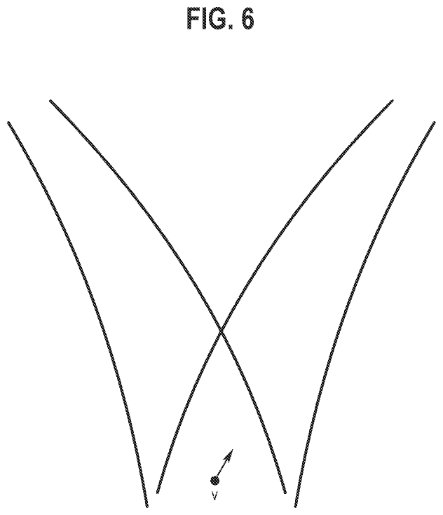

This embodiment will now be discussed in conjunction with in FIG. 5. As shown in FIG. 5, the one or more processors 102 determine if the vehicle is approaching a designated geographic area in a vehicle state (e.g., speed, position, direction of travel, and/or a braking state) that would activate an alarm of the safety system when the vehicle enters the designated area (act 510). As discussed above, this can be done in any suitable way, such as by obtaining a location of the vehicle from the vehicle's GPS 116 and then determining if the location of the vehicle is within a threshold distance or time of a designated geographic area marked on the map as having a high true-alert condition.

If the vehicle is determined to be approaching the designated geographic area, the one or more processors 102 can optionally determine what condition exists when the vehicle is approaching the designated area (act 520). For example, it may be desired to generate the preemptive alert only when the condition satisfies a criterion, such as, but not limited to, a designated time, a designated date, a designated weather condition, a designated road condition, and/or a designated vehicle condition threshold. More specifically, some signs are time-dependent or circumstance-dependent. For instance, if there is a long daily 4-6 pm queue at a hill-bottom intersection, a speed sign may be turned on further up the hill or set with a different value. If there is ice at the bottom of the hill or in a blind curve, the speed may be similarly limited earlier or more drastically. This time-, traffic-, and weather-dependence may be stored along with the proactive alarm warning location. If it is 4.30 pm, the zone is active. If it is 8 pm and the vehicle reads a temperature of less than say 5 degrees C., the alarm may be active again. If none of the exceptional circumstances apply, no warning (or a reduced warning) may be issued.

Next, if the condition is satisfied, the one or more processors 102 can issue an advisory alert to alert the driver of the vehicle to change the vehicle state to avoid activation of the alarm when the vehicle enters the designated area (act 540). Again, as mentioned above, providing the preemptive advisory alarm can help the driver avoid the generation of a true alarm.

There are many alternatives that can be used with these embodiments. For example, the map 122 can be updated (e.g., via the transceiver 108) over time with collated localized high-alarm-frequency locations or areas with “incorrect” sign locations. Additionally, the one or more processors 102 can store a trigger-condition signal time history for the alarm and associated geographic location for future evaluation for possible future trigger-condition revision.

In another alternative, a system for potential map confusion detection is provided. Map confusion is detected from either unusually-high local alarm rates or unusually-low alarm rates relative to the locally-posted limit. The one case is repeatedly exceeding the locally-visible limit or advice, and the other is repeatedly subceeding the locally-visible limit. The system may learn the correct lower or higher local limit from a statistic of the actually-driven local speed. For example, speed percentiles, the speed distribution mode, or a trimmed median value (e.g., 5 MPH less) may be used for this local speed limit instead of the locally-visible one. The obverse case corresponds to an e.g., 65 MPHh highway speed limit sign being visible from the frontage road. The learned speed limit may be used for alternative warning issuance or suppression.

In yet another alternative, instead of using a map in the memory of the vehicle, the position of the vehicle (e.g., the vehicle's latitude/longitude coordinate) is checked against a list or database of geofences (e.g., top-left and bottom-right latitude/longitude coordinate) as the vehicle approaches an area of concern, which would potentially reduce the cost and intensiveness of the computing involved. For simplicity, the term “data structure” is used herein to refer to a map, list, database, or any other type of data structure that can hold information used to determine if a vehicle is entering a geographical area of interest. This data structure may be located, in whole or in part(s), in any location in the signal processing chain. For instance, a vehicle may ‘understand’ that an alarm it has just issued is possibly a false positive (e.g. ‘there are false alarm areas in state XYZ’), and transmit this fact to backend processing, where a further, geographically precise, final decision is made as to the truth or falsity of the alarm. The initial, coarse, in-vehicle decision may be based on e.g. the event's integer latitude and longitude location values.

In another alternative, a backend process (e.g., on a server) is performed to determine whether or not an alarm generated by a vehicle is a false alarm (so, no changes to the vehicle would be needed). In this embodiment, the server would receive, from the vehicle, an indication that an alarm was generated when the vehicle entered a geographic area. The server can then determine whether the alarm was a false alarm based on a history of false alarms in the geographic area. If the alarm is determined to be a false alarm, the server can refrain from placing the indication on the driver's record. Alternatively, if the indication was already placed on the driver's record, the indication can be removed. This process can be performed at any time, and, in one embodiment, is performed while map data is being updated for the vehicle. In contrast, where the history of the area shows that drivers only very seldom reach the locally-posted visible speed limit (one would expect some percentage to exceed the limit), the alarm can be deemed genuine, and the indication can be placed on (and not expunged from) the driver's record.

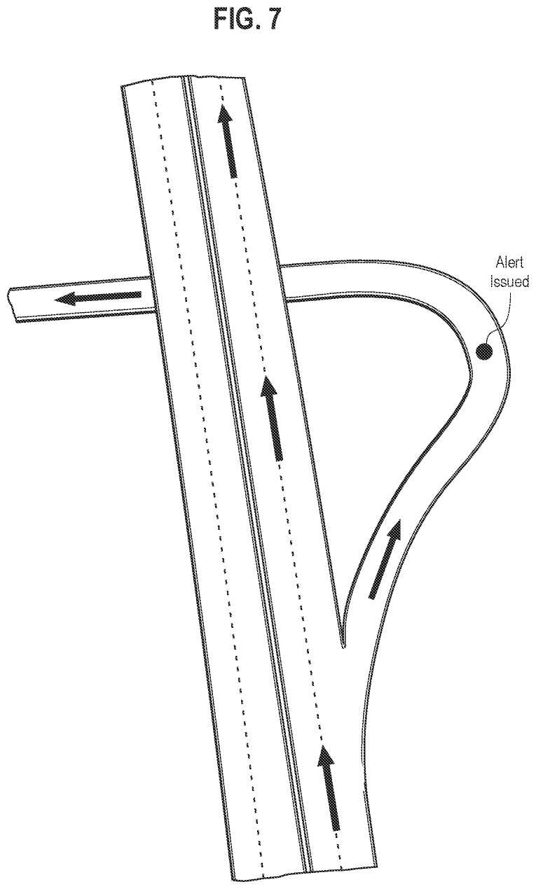

Finally, in both the false-alert-prevention and preemptive-alert embodiments discussed above, a determination was made as to whether the vehicle is approaching a designated area on a map. However, as shown in FIG. 6, in some situations, such as a fork in the road, distance or time may not be dispositive. Forks in roadways can create problems for systems that use geolocation, particularly when an action shall result from one particular side of the fork but not the other. Another example (shown in FIG. 7) is where a sudden curve on a road on one side of the fork side elicits a preventative warning, but the road on the other side does not.

In one embodiment, a big-data-based geolocation resolution mechanism can be used to identify which side of the fork applies. The vehicle's safety system can collect vehicle position data at one-second intervals. As vehicles traverse the fork, the vehicles leave positional trails, and a processor can identify a bundle of trajectories associated with each “tine” of the fork. The trajectories can contain both location and vectoral speed information, which can be derived from successive position data. The trajectory bundles progressively diverge over the fork and are entirely separated at some point. The outer bounds may be defined for each bundle (an envelope for them). These outer bounds are the lateral extremes of the trajectories going into each fork. They overlap at the beginning and then split. A vehicle has both a position (which may not be helpful in deciding which part of the fork applies) and a more-indicative velocity vector, which points at where the vehicle is going. A table may be created that contains position, speed, and direction of travel data of the vehicles that go left or right. Each entry in the table can be labeled with left or right. The entry in the table that most closely matches the position, speed, and direction of travel data for a new vehicle coming in can be chosen for deciding which side of the fork applies.

Many variations are possible. For instance, a system may choose to only store data for that side of the fork that results in an action. If a new vehicle's position, speed, and direction of travel are close enough to any of these trajectories, it may be deemed as going toward that side of the fork. Also, a majority voting mechanism (e.g., a k-nearest neighbor classifier) may be applied for deciding which fork tine the vehicle is approaching. For instance, if at least three of the five nearest neighbors predict that the vehicle is not going to the fork tine that requires an action, that action is not initiated. Also, instead of using extreme lateral locations (extrema are subject to noise), percentile lateral positions can be used instead (e.g., taking say the 10^{th} and 90^{th} lateral position percentiles to describe the bundle). Additionally, extreme simplification can be applied, with only two position/speed/direction points defining each branch. At the spot where the warning shall be issued or not, it can be decided which point the current position/speed/direction is closer to or “pointing at” and on that basis, issue the warning or not.

The action or warning itself may be modified. An example might be to give a “narrower,” more-descriptive “watch exit speed” warning in some situations (e.g., for dangerous exits that require slow speeds) and a less-specific “watch speed” warning in other situations. The more-specific warning may be given earlier, and this principle of additional specificity can be generally applied.

Alternatively, instead of figuring out which branch the vehicle will traverse, the one or more processors 102 can issue a right-side or left-side curve speed warning in any case (e.g., warn that an event occurs frequently on a particular branch such as “left exit speed warning”). Even if the vehicle does not take the left exit, the driver would still have been informed and can simply disregard this information. That is, instead of the electronic system trying to understand where the driver is going, the driver can be informed and decide if the information is relevant. If the proactive warning areas are infrequent, this should not overly disturb the driver, and it even has the advantage of sensitizing them for the future regarding the local issues.

It should be understood that all of the embodiments provided in this Detailed Description are merely examples and other implementations can be used. Accordingly, none of the components, architectures, or other details presented herein should be read into the claims unless expressly recited therein. Further, it should be understood that components shown or described as being “coupled with” (or “in communication with”) one another can be directly coupled with (or in communication with) one another or indirectly coupled with (in communication with) one another through one or more components, which may or may not be shown or described herein. Additionally, “in response to” can be directly in response to or indirectly in response to.

It is intended that the foregoing detailed description be understood as an illustration of selected forms that the invention can take and not as a definition of the invention. It is only the following claims, including all equivalents, which are intended to define the scope of the claimed invention. Accordingly, none of the components, architectures, or other details presented herein should be read into the claims unless expressly recited therein. Finally, it should be noted that any aspect of any of the embodiments described herein can be used alone or in combination with one another.

What is claimed is:

1. A non-transitory computer-readable storage medium storing computer-readable instructions that, when executed by one or more processors in a vehicle, cause the one or more processors to:
determine whether the vehicle is approaching a designated geographic area; and
in response to determining that the vehicle is approaching the designated geographic area, perform at least one of the following:
suppress an alarm that would overwise be activated when the vehicle is in the designated geographic area; or
indicate that the alarm, if activated when the vehicle is in the designated geographic area, is a false alarm.

2. The non-transitory computer-readable storage medium of claim 1, wherein the alarm comprises: an excessive speed alarm, a lane departure alarm, an excessive braking alarm, an excessive curve speed alarm, an electronic stability control (ESC) alarm, an electronic stability program (ESP) alarm, a roll stability control (RSC) alarm, and/or a roll stability program (RSP) alarm.

3. The non-transitory computer-readable storage medium of claim 1, wherein the computer-readable instructions, when executed by the one or more processors, further cause the one or more processors to determine which of a plurality of alarms to suppress.

4. The non-transitory computer-readable storage medium of claim 1, wherein the computer-readable instructions, when executed by the one or more processors, further cause the one or more processors to:
determine a condition that exists when the vehicle is approaching the designated geographic area;
wherein the alarm is suppressed or indicated to be a false alarm in response to the condition satisfying a criterion.

5. The non-transitory computer-readable storage medium of claim 4, wherein the criterion comprises a designated time, a designated time period, a designated date, a designated weekday, a designated weather condition, and/or designated a road condition.

6. The non-transitory computer-readable storage medium of claim 1, wherein:
the designated geographic area is marked in a map stored in a memory of the vehicle; and
determining whether the vehicle is approaching the designated geographic area comprises:
obtaining a location of the vehicle from a global positioning system (GPS); and
determining whether the location is within a threshold distance or time of the designated geographic area marked on the map.

7. The non-transitory computer-readable storage medium of claim 6, wherein determining whether the vehicle is approaching the designated geographic area further comprises:
determining whether a vector of the vehicle is in a direction of the designated geographic area marked on the map.

8. The non-transitory computer-readable storage medium of claim 6, wherein the computer-readable instructions, when executed by the one or more processors, further cause the one or more processors to:
receive an updated map with collated localized high-alarm-frequency locations.

9. The non-transitory computer-readable storage medium of claim 1, wherein:
the designated geographic area is designated in a data structure stored in the vehicle.

10. The non-transitory computer-readable storage medium of claim 1, wherein the computer-readable instructions, when executed by the one or more processors, further cause the one or more processors to:
store a trigger-condition history for the alarm and associated geographic location for future evaluation.

11. A method comprising:
performing in one or more processors in a vehicle:
determining whether the vehicle is approaching a designated geographic area in a vehicle state that would activate an alarm when the vehicle enters the designated area; and
in response to determining that the vehicle is approaching the designated geographic area in the vehicle state that would activate the alarm, issuing an advisory alert to alert a driver of the vehicle to change the vehicle state to avoid activation of the alarm when the vehicle enters the designated area.

12. The method of claim 11, wherein the alarm comprises: an excessive speed alarm, a lane departure alarm, an excessive braking alarm, an excessive curve speed alarm, an electronic stability control (ESC) alarm, an electronic stability program (ESP) alarm, a roll stability control (RSC) alarm, and/or a roll stability program (RSP) alarm.

13. The method of claim 11, wherein the vehicle state comprises a speed of the vehicle, a position of the vehicle, and/or a braking state of the vehicle.

14. The method of claim 11, further comprising;
determining a condition that exists when the vehicle is approaching the designated geographic area;
wherein the advisory alarm is issued in response to the condition satisfying a criterion.

15. The method of claim 14, wherein the criterion comprises a designated time, a designated date, a designated weather condition, and/or designated a road condition.

16. The method of claim 11, wherein:
the designated geographic area is marked in a map stored in a memory of the vehicle; and
determining whether the vehicle is approaching the designated geographic area comprises:
obtaining a location of the vehicle from a global positioning system (GPS); and
determining whether the location is within a threshold distance or time of the designated geographic area marked on the map.

17. The method of claim 16, wherein determining whether the vehicle is approaching the designated geographic area further comprises:
determining whether a vector of the vehicle is in a direction of the designated geographic area marked on the map.

18. The method of claim 16, further comprising:
receiving an updated map with collated localized high-alarm-frequency locations.

19. The method of claim 11, further comprising:
storing a trigger-condition history for the alarm and associated geographic location for future evaluation.

20. The method of claim 11, wherein:
the designated geographic area is designated in a data structure stored in the vehicle.

21. A vehicle comprising
a safety system; and
at least one of the following:
means for suppressing an alarm of the safety system that would otherwise be activated when the vehicle is in a geographic area;
means for indicating that the alarm, if activated when the vehicle is in designated geographic area, is a false alarm; or
means for issuing an advisory alert to alert a drive of the vehicle to change a vehicle state to avoid activation of the alarm when the vehicle is in the geographic area.

22. The vehicle of claim 21, further comprising:
means for obtaining a location of the vehicle from a global positioning system (GPS); and
means for determining that the location is within a threshold distance or time of the designated geographic area marked on a map stored in a memory of the vehicle.

23. The vehicle of claim 21, wherein:
the designated geographic area is designated in a data structure stored in the vehicle.

24. A non-transitory computer-readable storage medium storing computer-readable instructions that, when executed by one or more processors, cause the one or more processors to:
receive, from a vehicle, an indication that an alarm was generated when the vehicle entered a geographic area;
determine whether the alarm was a false alarm based on a history of false alarms in the geographic area; and
in response to determining that the alarm was a false alarm, perform at least one of the following:
refrain from placing the indication on a record of a driver of the vehicle; or
remove the indication from the record of the driver of the vehicle.

25. The non-transitory computer-readable storage medium of claim 24, wherein the alarm comprises: an excessive speed alarm, a lane departure alarm, an excessive braking alarm, an excessive curve speed alarm, an electronic stability control (ESC) alarm, an electronic stability program (ESP) alarm, a roll stability control (RSC) alarm, and/or a roll stability program (RSP) alarm.

26. The non-transitory computer-readable storage medium of claim 24, wherein the determining is performed while map data is being updated for the vehicle.

27. The non-transitory computer-readable storage medium of claim 24, further comprising computer-readable instructions that, when executed by the one or more processors, cause the one or more processors to:
update a database in the vehicle after determining that another geographic area comprises a hotspot.

28. The non-transitory computer-readable storage medium of claim 24, wherein the determining is more precise that determining performed in the vehicle.
